(19) United States
(12) Patent Application Publication
(10) Pub. No.: US 2005/0181879 A1
(43) Pub. Date: Aug. 18, 2005

(54) Gaming terminal having secondary display

(76) Inventor: Wayne H. Rothschild, Northbrook, IL (US)

Correspondence Address: JENKENS & GILCHRIST, P.C., 225 WEST WASHINGTON, SUITE 2600, CHICAGO, IL, 60606, US

(21) Appl. No.: 10/782,090

(22) Filed: Feb. 18, 2004

(51) Int. Cl. A63F 13/00

(52) U.S. Cl. 463/46

(57) ABSTRACT

A gaming terminal for conducting a wagering game includes a wager-input device and a button panel located below the wager-input device. The button panel includes a plurality of mechanical buttons for receiving inputs from a player. The gaming terminal further includes a main display for displaying a randomly selected outcome from a plurality of outcomes and a secondary display for displaying information about the wager inputs received from the wager-input device and, during the wagering game, for displaying game-play information related to the plurality of outcomes. The secondary display is located between the button panel and the main display, contiguous with the button panel, and to the side of the wager-input device. The secondary display acts in unison with the main display to illustrate continuous movement of images related to the randomly selected outcome, the images moving between the main display and the secondary display.

### FIELD OF THE INVENTION

The present invention relates generally to gaming terminals and, more particularly, to a gaming terminal with a uniquely located secondary display, yielding a more ergonomically designed gaming terminal that has enhanced flexibility.

### BACKGROUND OF THE INVENTION

Gaming terminals, such as slot terminals, video poker terminals, and the like, have been a cornerstone of the gaming industry for several years. Generally, the popularity of such terminals with players is dependent on the likelihood (or perceived likelihood) of winning money at the terminal and the intrinsic entertainment value of the terminal relative to other available gaming options. Where the available gaming options include a number of competing terminals and the expectation of winning each terminal is roughly the same (or believed to be the same), players are most likely to be attracted to the most entertaining and exciting of the terminals.

Consequently, shrewd operators strive to employ the most entertaining and exciting terminals available, because such terminals attract frequent play and, hence, increase profitability to the operator. Additionally, gaming terminals that provide more comfort to the player are also important in attracting frequent play. Many gaming terminals possess a touch screen video display including a main display overlapped by a similarly sized touch screen. The touch screen is typically adhered or taped to a front panel of the main display. The touch screen allows players to determine and easily select game options during play, just like the button switches that are typically present on the gaming terminal.

However, in the typical gaming terminals, the main display is located quite a distance above the button panel where the player's hands may rest because that is the primary location where repetitious inputs are received. As a result, when using the touch screen of the main display, the player's hands must repeatedly move up and down between the button panel and the touch screen. As a further consequence of this hand movement, the player's head must repeatedly move up and down as the player has to shift focus back and forth to provide accurate inputs and confirm those inputs on the main display. These constant motions of the player's head and hands can be an annoyance to the player. The annoyance generally turns into discomfort as the player spends more time on the gaming terminal. And from the operator's perspective, the head and hand movement also decreases the speed at which the player can play the game, yielding a lower wager input rate.

Therefore, a need exists for an ergonomically designed gaming terminal that will provide a solution to the problems discussed above.

### SUMMARY OF THE INVENTION

The present invention relates to a gaming terminal for conducting a wagering game. The gaming terminal includes a housing having at least one wager-input device and a button panel located directly below the wager-input device on the housing. The button panel includes a plurality of mechanical buttons for receiving inputs from a player. The housing of the gaming terminal includes a main display and a secondary display. The main display is used for displaying a randomly selected outcome from a plurality of outcomes of the wagering game in response to receiving a wager at the wager-input device. The secondary display is located between the button panel and the main display, is contiguous with the button panel, and is to the side of the wager-input device. The secondary display is used for displaying information about the wager inputs received from the wager-input device and, during the wagering game, for displaying game-play information related to the plurality of outcomes.

The secondary display provides substantial versatility to the gaming terminal. For example, the secondary display can display a wager amount, account balance information, and player-tracking information. In another embodiment, the secondary display can display machine configuration information, including currency denomination, number of paylines available, and number of paylines selected. Further, the secondary display can entirely obviate the need for the traditional button panel.

The present invention also contemplates a novel method of conducting a wagering game on a gaming terminal having a main display, a secondary display, and a button panel with a plurality of mechanical buttons. The secondary display is located between the button panel and the main display. The method involves displaying, at the secondary display, information related to wager inputs received from a player at the gaming terminal. In response to the wager inputs, the gaming terminal conducts a wagering game that includes selecting a randomly selected outcome from a plurality of outcomes. The method also involves displaying, at the main and secondary displays, game-play information related to the wagering game.

In one preferred embodiment, the gaming terminal includes a housing having a wager-input device, a main display and a secondary display located within the housing, a touch screen over the secondary display for receiving inputs from a player, and a button panel. The main display is used for displaying a randomly selected outcome from a plurality of outcomes of the wagering game in response to a wager from the wager-input device. The secondary display is mounted below the main display and acts in unison with the main display to illustrate continuous movement of images related to the randomly selected outcome. The movement of the images takes place from the secondary display to the main display and from the main display to the secondary display. The button panel is mounted below and directly contiguous with the secondary display and includes a plurality of mechanical buttons for receiving inputs from the player.

The above summary of the present invention is not intended to represent each embodiment or every aspect of the present invention. The detailed description and figures will describe many of the embodiments and aspects of the present invention.

### BRIEF DESCRIPTION OF THE DRAWINGS

The foregoing and other advantages of the invention will become apparent upon reading the following detailed description and upon reference to the drawings.

FIG. 1 is a perspective view of a gaming terminal embodying the present invention.

FIG. 2 illustrates a control system that is used in conjunction with the gaming terminal of FIG. 1.

FIG. 3 is a schematic drawing showing a side view of a gaming terminal according to another embodiment of the present invention.

FIG. 4 is a perspective view of a gaming terminal having a top main display and a bottom main display according to yet another embodiment of the present invention.

FIG. 5A is a front view of a gaming terminal having a left secondary display with a touch screen and a right secondary display according to another embodiment of the present invention.

FIG. 5B is a front view of a gaming machine having a left secondary display and a right secondary display, each secondary display having a touch screen, according to another embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

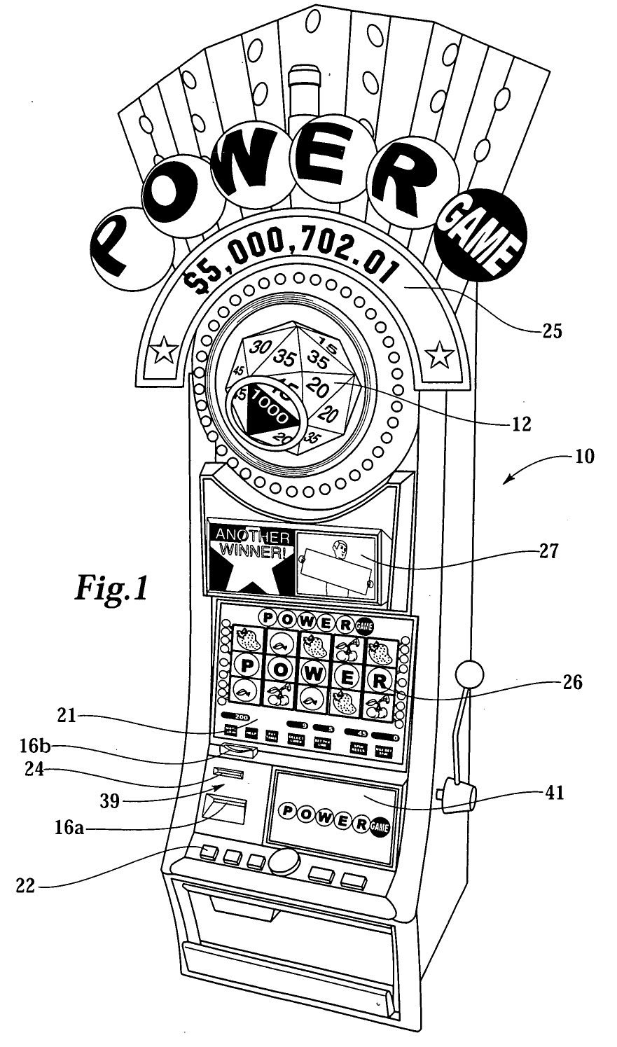

FIG. 1 shows a perspective view of a typical gaming terminal 10 used by gaming establishments, such as casinos. With regard to the present invention, the gaming terminal 10 may be any type of gaming terminal and may have varying structures and methods of operation. For example, the gaming terminal 10 may be a mechanical gaming terminal configured to play mechanical slots, or it may be an electromechanical or electrical gaming terminal configured to play a video casino game, such as blackjack, slots, keno, poker, etc. The gaming terminal 10 includes a “bonus” or “secondary” game that can be achieved in the basic game and the results are shown in a bonus game region 12 of the housing of the gaming terminal 10.

As shown, the gaming terminal 10 includes input devices, such as a wager acceptor 16 (shown as a card wager acceptor 16a and a cash wager accepter 16b), a touch screen 21, a push-button panel 22, and a player-identification card reader 24. For outputs, the gaming terminal 10 includes a top progressive game display 25 for displaying the value of a progressive game, a main display 26 for displaying information about the basic wagering game, and a bottom progressive game display 27 that displays progressive game information or other entertainment features. While these typical components found in the gaming terminal 10 are described below, it should be understood that numerous other elements may exist and may be used in any number of combinations to create various forms of a gaming terminal.

The wager acceptor 16 may be provided in many forms, individually or in combination. The cash wager acceptor 16a may include a coin slot acceptor or a note acceptor to input value to the gaming terminal 10. The card wager acceptor 16b may include a card-reading device for reading a card that has a recorded monetary value with which it is associated. The card wager acceptor 16b may also receive a card that authorizes access to a central account, which can transfer funds to the gaming terminal 10. Alternatively, the wager input device 16 can be a network-based account. For example, a player can simply use a personal code to access a line of credit provided by a gaming establishment.

The push-button panel 22 is typically offered, in addition to the touch screen 21 overlying the main display 26, to provide players with an option on how to make their game selections. The push-button panel 22 includes a plurality of mechanical buttons, which can be arranged in various ways. Alternatively, the buttons of the push-button panel 22 are a plurality of proximity sensors, which can be used instead of or in addition to the mechanical buttons. The mechanical buttons can be used for selecting lines, for cashing out, for calling an attendant, for spinning reels, for initiating a bonus event, for selecting a bonus, and for game play interactivity. For example, the mechanical buttons can be used to initiate a gaming session by starting the spinning of reels, to stop the spinning of the reels, and to increase the number of credits. Alternatively, the push-button panel 22 provides inputs for one aspect of operating the game, while the touch screen 21 allows for inputs needed for another aspect of operating the game. In another embodiment, the push-button panel 22 can be a touch screen with fixed artwork. Optionally, the push-button panel 22 is a video display with a touch screen overlying at least a portion of the video display. In another embodiment, the touch screen 21 is used instead of the push-button panel 22.

The operation of the basic wagering game is displayed to the player on the main display 26. The main display 26 may take the form of a cathode ray tube (CRT), a high resolution LCD, a plasma display, LED, or any other type of video display suitable for use in the gaming terminal 10. As shown, the main display 26 includes the touch screen 21 overlaying the entire monitor (or a portion thereof) to allow players to make game-related selections. Alternatively, the gaming terminal 10 may have a number of mechanical reels to display the game outcome.

The player-identification card reader 24 allows for the identification of a player by reading a card with information indicating his or her identity. Currently, the identification is used by casinos for rewarding certain players with complimentary services or special offers. For example, a player may be enrolled in the gaming establishment's players' club and may be awarded certain complimentary services as that player collects points in his or her player-tracking account. The player inserts his or her card into the player-identification card reader 24, which allows the casino's computers to register that player's wagering at the gaming terminal 10. Alternatively, the card reader 24 can be a financial account access device or a financial value storage device (e.g., a smart card). A player can use the card to transfer money into and out of the gaming terminal 10.

The cash wager acceptor 16a, the card wager acceptor 16b, and the player-identification card reader 24 are located in a gaming input region 39 of the housing of the gaming terminal 10 where the various types of wages and information about the player are inputted into the gaming terminal 10. The gaming input region 39 may also include a keypad for receiving player inputs. In a gaming terminal 10 where player tracking is important, the gaming input region 39 can be considered a player-tracking input region. The gaming input region 39 is different from the touch screen 21 or the button panel 22 in that the touch screen 21 and the button panel 22 typically provide game-play inputs (e.g., player selections) during the wagering games being conducted at the gaming terminal 10.

The gaming terminal 10 also includes a secondary display 41 that is located between the main display 26 and the button panel 22. The secondary display 41 is located directly adjacent to the gaming input region 39 on the gaming terminal and contiguous with the button panel 22. Alternatively, the secondary display 41 is located in any position near the gaming input region 39 and separated by aesthetic trim structures or lighting devices. The secondary display 41 is useful for displaying information about the inputs received at the gaming input region 39. For example, the secondary display 41 can depict wagering information or a denomination selection menu. In a gaming terminal 10 where player tracking is important, the information on the secondary display 41 may be directly related to the player's player-tracking account and provide real-time updates as the player makes wagers at the gaming terminal 10. By providing the secondary display 41 adjacent to the button panel 22 and the gaming input region 39, the player's head requires little, if any, movement when adjusting his or her eyesight between the gaming input region 39 and the secondary display 41, which displays information related to the inputs received from the gaming input region 39.

Further, the secondary display 41 can be outfitted with a touch screen so as to provide player inputs directly adjacent to the button panel 22. In one embodiment, the touch screen can be similar or the same as the touch screen 21 that is shown overlying a portion of the main display 26. This is particularly advantageous in that it allows for a wide range of inputs while requiring little, if any, hand movement from the button panel 22. For example, the secondary display 41 can be used to provide for game-play inputs that are needed during the basic wagering game, the bonus game, and/or the progressive wagering game. This is particularly useful in that, while the button panel 22 provides a known set of game-play inputs, the touch screen on the secondary display 41 can provide variable game-play inputs, as needed, depending on whether the gaming terminal 10 is conducting the basic wagering game, the bonus game, and/or the progressive wagering game. The game-play inputs can be game-play selection options that the player selects in the process of determining the random outcome. The touch screen can also receive wager inputs and player-tracking inputs.

In one preferred embodiment, the secondary display 41 displays information related to the inputs related to the wager and the identification of the player that are received by the gaming input region 39. Then, after these inputs from the gaming input region 39 are received and the wagering games begin, the secondary display 41 displays information about the wagering games, and also possibly receives game-play inputs via a touch screen from the player during the basic wagering game, the bonus game, and/or the progressive wagering game. This is particularly helpful if the gaming terminal 10 is a mechanical slot machine, wherein the main display 26 is replaced by a plurality of mechanical reels. If the main display 26 includes only mechanical reels, any other information (e.g., game-play inputs) can be shown on the secondary display 41.

In another embodiment, the secondary display 41 acts in unison with the main display 26 for displaying information related to the randomly selected game outcome. Thus, images related to the game outcome are illustrated as being moved in a continuous motion from the secondary display 41 to the main display 26 and from the main display 26 to the secondary display 41. These images may be the symbols that are indicative of the randomly selected outcome.

In another preferred embodiment, a middle portion of the button panel 22 is disposed at a height such that physical discomfort is minimized when an average seated player operates the button panel 22. Ergonomic research indicates that a preferred position for minimizing discomfort when operating a keyboard is having a person's forearms held at approximately a 90 degree angle from the upper arms. For an average seated player, this position ranges from about 30 inches to about 35 inches above the floor. The main display 26, which is located above the button panel 22, is positioned approximately at about the eye level of an average seated person. The center point of the main display 26 is preferably between about 50 inches to about 58 inches above the floor. Having the main display 26 at about the eye level, of an average seated player, allows the player to assume a posture that is both visually and posturally comfortable, and allows the eyes of the player to assume a comfortable gaze angle.

The secondary display 41 is preferably located near the button panel 22 for minimizing any motion of a player's hand from the button panel 22 to the secondary display 41. Therefore, when a player is required to input information via the touch screen on the secondary display 41, the discomfort associated with hand motions is considerably reduced by having the secondary display 41 mounted near, e.g., above and contiguous with, the button panel 22 and under the main display 26. Preferably, the distance from the top of the button panel 22 to the bottom of the secondary display 41 is about zero to eight inches.

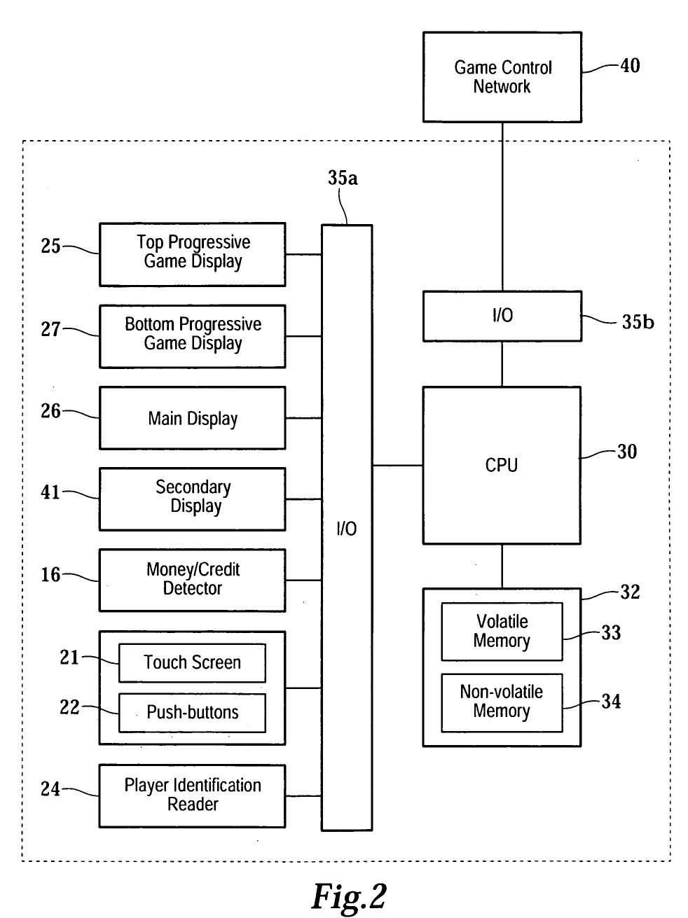

As shown in FIG. 2, the various components of the gaming terminal 10 are controlled by a central processing unit (CPU) 30 (such as a microprocessor or microcontroller). To provide the gaming functions, the CPU 30 executes a game program that allows for a randomly selected outcome. The CPU 30 is also coupled to or includes a system memory 32. The system memory 32 may comprise a volatile memory 33 (e.g., a random-access memory (RAM)) and a non-volatile memory 34 (e.g., an EEPROM). It should be appreciated that the CPU 30 may include one or more microprocessors. Similarly, the memory 32 may include multiple RAM and multiple program memories.

Communications between the peripheral components of the gaming terminal 10 and the CPU 30 occur through input/output (I/O) circuits 35a. As such, the CPU 30 also controls and receives inputs from the peripheral components of the gaming terminal 10. Further, the CPU 30 communicates with external systems via the I/O circuits 35b. Although the I/O circuits 35 may be shown as a single block, it should be appreciated that the I/O circuits 35 may include a number of different types of I/O circuits.

The gaming terminal 10 is typically operated as part of a game control network 40 having control circuitry and memory devices. The gaming terminal 10 often has multiple serial ports, each port dedicated to providing data to a specific host computer system that performs a specific function (e.g., accounting system, player-tracking system, progressive game control system, etc). To set up a typical serial communication hardware link to the host system, the typical RS-232 point-to-point communication protocol that is often present in the gaming terminal 10 is converted to an RS-485 (or RS-485-type) master-slave protocol so as to take advantage of some of the advantages of the RS-485 capability (e.g., multi-drop capability that allows many gaming terminals 10 to communicate with the game control network 40). To perform this function, a custom interface board may be used by the gaming terminal 10 for each communication port in the gaming terminal 10. It should be noted that the gaming terminal 10 can initially be designed to be configured for a typical RS-485protocol, instead of the typical RS-232 protocol. Further, the gaming terminal 10 may simply be designed for an Ethernet connection to the game control network 40.

Further, the gaming terminal 10 can lack the CPU 30 such that the wager-related processing and the random outcome selections for the gaming terminal is performed within the game control network 40. In essence, the gaming terminal 10 is simply an input station for receiving inputs from the players and an output station for displaying the randomly selected outcomes and other information to the player. In such an embodiment where the CPU 30 is not present, the gaming terminal 10 may have a display controller that controls the information and images displayed on the main display 26, progressive displays 25, 27, and the secondary display 41 based, at least in part, on commands received from the game control network 40. Such a display controller could be linked to these displays like the CPU 30 shown in FIG. 2.

The touch screen 21, can be located on either one or both of the main display 26 and secondary display 41. While in FIG. 1 the touch screen 21 is located overlying the main display 26, FIG. 2 shows that the touch screen 21 is not limited to use solely with the main display 26.

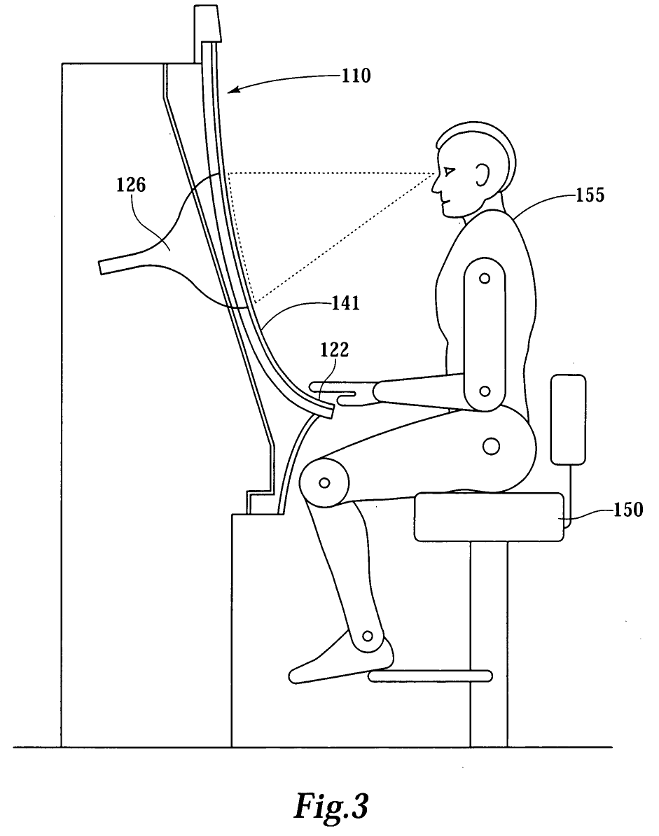

FIG. 3 describes a gaming terminal 110 in accordance with another embodiment of the present invention, but with an overall configuration that is different from the gaming terminal 10 of FIG. 1. FIG. 3 includes 100-series reference numerals for items that are the same as those described with respect to FIGS. 1-2. The gaming terminal 110 includes a button panel 122 located below a main display 126. A secondary display 141 is located between the button panel 122 and the main display 126. The secondary display 141 performs the functions discussed above with respect to the secondary display 41 in the gaming terminal 10 of FIG. 1.

A player 155 seated on a chair 150 experiences the ergonomic features of the gaming terminal 110. To minimize physical discomfort when operating a gaming terminal 110, the button panel 122 and the touch screen located over the secondary display 141 are placed at approximately elbow height. Accordingly, the player 155 seated on the chair 150 will be more comfortable in using the gaming terminal 110. Further, the inputs at the button panel 122 and the touch screen on the secondary display 141 can be made with minimal hand movement.

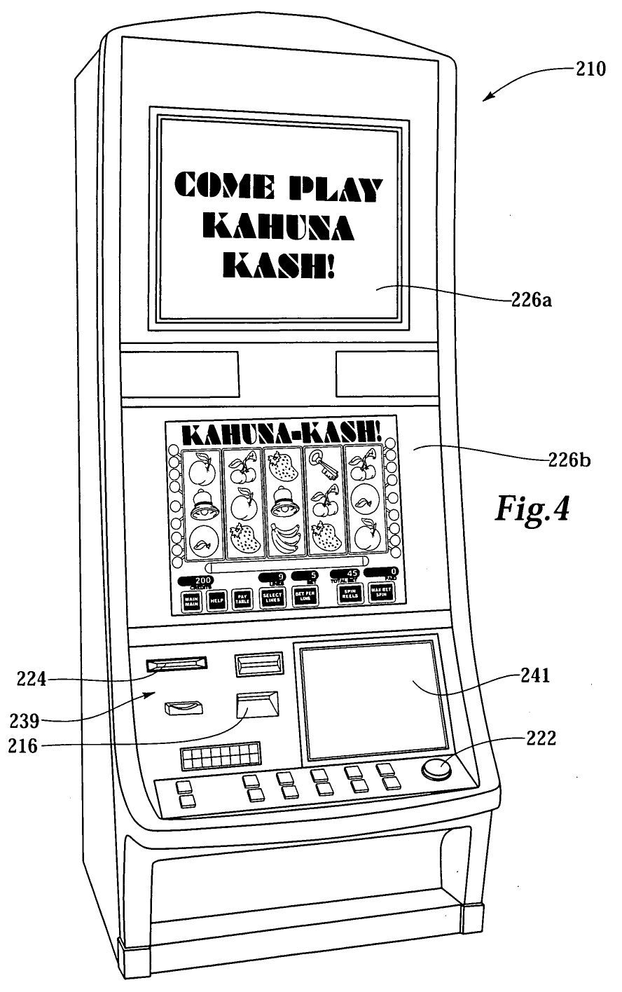

Referring now to FIG. 4, a gaming terminal 210 in accordance with another embodiment of the present invention includes a top main display 226a and a bottom main display 226b. The top main display 226a can be used as an advertisement tool for attracting players to the gaming terminal 210. For example, the top main display 226a can be used to invite potential players to “COME PLAY KAHUNA KASH!,” as shown in FIG. 4, or to provide information regarding the wagering game, such as a statistical incentive to the potential players informing them that “A BIG WINNER EVERY TEN MINUTES AT KAHUNA KASH!” The bottom main display 226b displays game-play information during the operation of the wagering game. Alternatively, the top main display 226a displays game-play information during the operation of the wagering game and the bottom main display 226b is used to invite potential players to “COME PLAY KAHUNA KASH!,” as shown in FIG. 4, or to provide information regarding the wagering game, such as a statistical incentive to the potential players informing them that there is “A BIG WINNER EVERY TEN MINUTES AT KAHUNA KASH!” In yet another embodiment, a number of mechanical reels may be used to display the game outcome instead of the bottom main display 226a.

In another embodiment, the top main display 226a and the bottom main display 226b act in unison to illustrate continuous movement of images from the top main display 226a to the bottom main display 226b and from the bottom main display 226b to the top main display 226a. For example, in a game of poker the shuffling of a deck of cards can be displayed on the top main display 226a, the dealing of the cards can be shown on the bottom main display 226b, the cards moving in a continuous motion from the top main display 226a to the bottom main display 226b, and the winning outcome can be displayed on the top main display 226b. Optionally, the top main display 226a includes a touch screen for accepting any inputs from the player.

The gaming terminal 210 further includes a gaming input region 239 for accepting player inputs such as a player identification card reader 224 and a wager acceptor 216. The gaming input region 239 is located below the bottom main display 226b and above a button panel 222. A secondary display 241 is located above the button panel 222, below the bottom main display 226b and to the right of the gaming input region 239. The secondary display 41 can display information related to the inputs received in the gaming input region 239, can accept further inputs from the player via a touch panel overlying the secondary display 241, or can do both. Alternatively, the secondary display 241 acts in unison with the top and bottom main displays 226a, 226b for illustrating continuous movement of images pertaining to a basic wagering game, a bonus game, or a progressive wagering game. The images can move continuously from any one of the secondary display 241 and the top and bottom main displays 226a, 226b to any one of the secondary display 241 and the top and bottom main displays 226a, 226b.

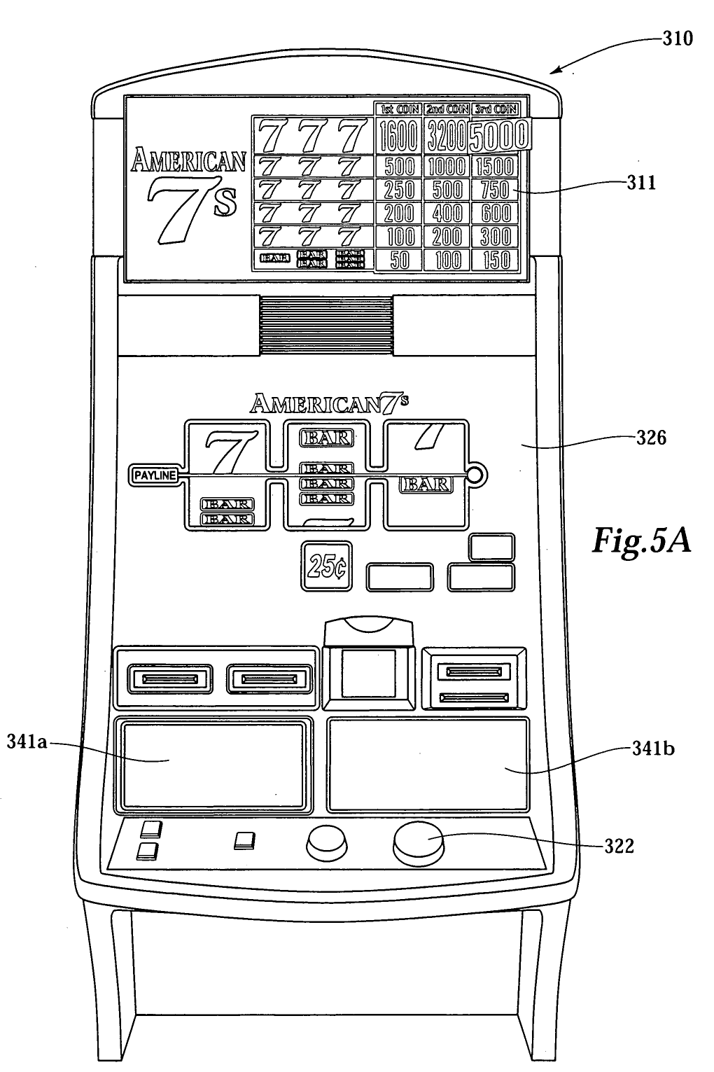

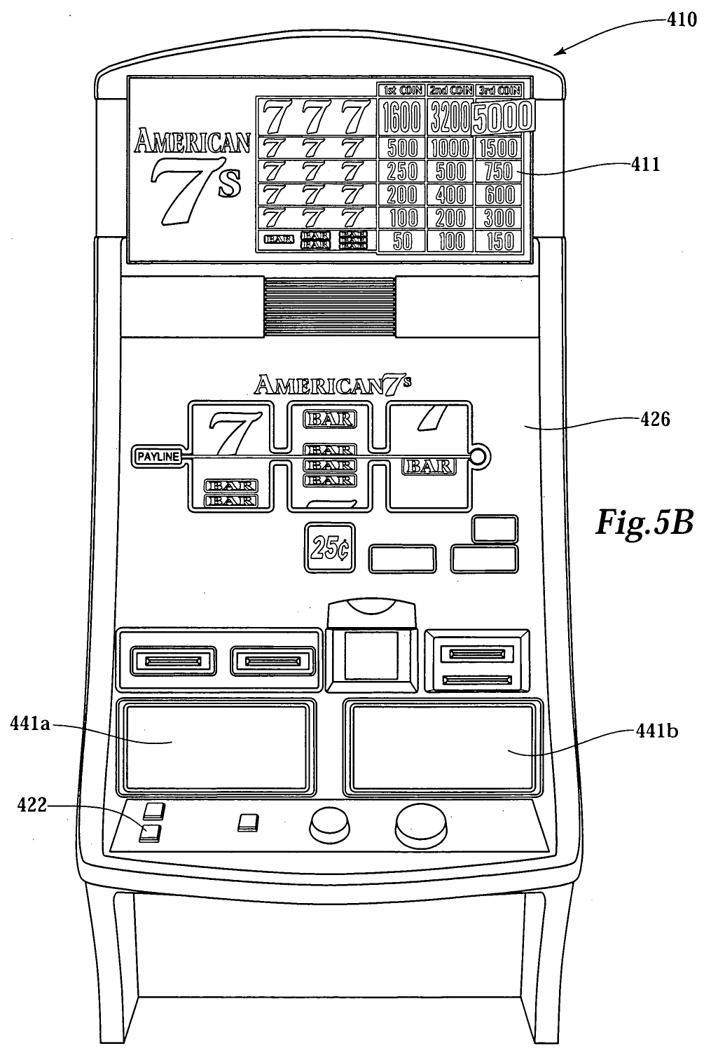

Referring now to FIG. 5A, a gaming terminal 310 includes a pay table 311 for showing winning combinations, a main display 326 located below the pay table 311 for showing a basic wagering game, and a button panel 322. The gaming terminal 310 further includes a left secondary display 341a and a right secondary display 341b, each of which is located above the button panel 322 and below the main display 326. The left secondary display 341a includes a touch screen for accepting inputs from a player, the inputs being related to player identification, player tracking, and any other inputs not required for conducting the wagering game, bonus game, or progressive game. The right secondary display 341b, which does not include a touch screen, displays information related to the inputs received in the left secondary display 341 a. For example, the right secondary display can show statistical information regarding the player, which can be based on the player's record on the same type of gaming machine (e.g., poker machines) for the last three months.

In another embodiment, the pay table 311 can be shown in any video display or as a fixed artwork. For example, the pay table 311 can be shown in the main display 326, or in the secondary displays 341a and 341b. Optionally, a video display can show the advancing of the pays of the pay table 311 according to at least one of the following criteria: wagered coins, bonus spins, and bonus pay events.

Alternatively, either or both of the secondary displays 341a and 341b can be provided with or without a touch screen. Alternatively yet, either or both of the secondary displays 341a and 341b can be adapted for having picture-in-picture or split-screen capability. Thus, the secondary displays 341a and 341b can be used in any conceivable combination with a touch screen, a picture-in-picture or a split-screen feature, or any other similar features.

In another embodiment, the left secondary display 341a can be used to provide concierge services to the player. Because a casino establishment has an incentive to keep a player next to a gaming terminal for as long as possible, a player can order food, drinks, and snacks via the left secondary display 341a without ever leaving the gaming terminal 310. The right secondary display 341b may show the player a menu, the total tab, and how long for the order to be ready. Similarly, the left secondary display 341a can be used to check emails, surf the web, and make reservations. Of course, it should be obvious that the functions of the left and right secondary displays 341a, 341b can be reversed.

Referring to FIG. 5B, a gaming terminal 410 includes a pay table 411, a main display 426, a button panel 422, a left secondary display 441a, and a right secondary display 441b. In this embodiment, both secondary displays 441a, 441b have touch screens overlying them. Thus, a player can use both secondary displays 441a, 441b to receive input information. Each of the secondary displays 441a, 441b can receive input information. For example, the left secondary display 441a can be used for inputting player identification information, while the right secondary display 441b can be used for inputting wagering information, or vice versa. Further, it should be understood that either one or both of the secondary displays 441a, 441b can also be used to input game-play information related to the basic wagering game, the progressive game, or the bonus game.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

1. A gaming terminal for conducting a wagering game, comprising:
a housing having wager-input means;
a button panel located directly below said wager-input means on said housing and including a plurality of buttons for receiving wager inputs from a player;
a main display located within said housing, said main display for displaying a randomly selected outcome from a plurality of outcomes of said wagering game in response to receiving a wager at said wager-input means; and
a secondary display located within said housing between said button panel and said main display, said secondary display being to the side of said wager-input means, said secondary display displaying information about said wager inputs received from said wager-input means and, during said wagering game, displaying game-play information related to said plurality of outcomes.

2. The gaming terminal of claim 1, wherein said secondary display is directly contiguous with said button panel and directly to the side of said wager-input means.

3. The gaming terminal of claim 1, wherein said main display and said secondary display act in unison to illustrate continuous movement of images from said main display to said secondary display and from said secondary display to said main display.

4. The gaming terminal of claim 1, further comprising a touch screen overlaying at least a portion of said main display.

5. The gaming terminal of claim 1, further comprising a touch screen overlaying at least a portion of said secondary display.

6. The gaming terminal of claim 5, wherein said touch screen receives game-play inputs, said game-play inputs being player selections related to said randomly selected outcome of said wagering game.

7. The gaming terminal of claim 1, further comprising a third display for displaying information about a bonus game or a progressive game, said third display being mounted above said main display.

8. The gaming terminal of claim 7, wherein said third display is adapted to show a pay table indicating the payout amounts for winning outcomes of said plurality of outcomes.

9. The gaming terminal of claim 7, wherein said third display is adapted to show advertising information.

10. The gaming terminal of claim 7, wherein said third display and at least one of said main display and said secondary display act in unison to illustrate continuous movement of images from said third display to said at least one of said main display and said secondary display and from said at least one of said main display and said secondary display to said third display.

11. The gaming terminal of claim 7, wherein said third display includes a touch screen overlying at least a portion of said third display.

12. The gaming terminal of claim 1, wherein said main display and said secondary display are each selected from a group consisting of a cathode ray tube, a high resolution LCD, a plasma display, and a LED.

13. The gaming terminal of claim 1, wherein said housing includes a gaming input region including at least one of said wager-input means and a player-identification input device, said gaming input region receiving said wager inputs and information about the player.

14. The gaming terminal of claim 13, wherein said player-identification input device is a card reader.

15. The gaming terminal of claim 11, wherein said wager-input means includes at least one of a card-reading device and a cash wager-input means, said cash wager-input means including at least one of a coin slot input device and a note input device.

16. The gaming terminal of claim 14, wherein said gaming input region is located on said housing below said main display, above said button panel, and next to said secondary display.

17. The gaming terminal of claim 1, wherein a middle portion of said button panel is disposed at a height ranging from about 30 inches to about 35 inches above the floor on which said housing sits.

18. The gaming terminal of claim 17, wherein the distance from the top of said button panel to the bottom of said secondary display is about zero inches to about eight inches.

19. The gaming terminal of claim 1, wherein said wagering game is selected from a group consisting of slots, poker, keno, bingo, blackjack, and roulette.

20. The gaming terminal of claim 1, wherein said gaming terminal includes a CPU for determining said randomly selected outcome from said plurality of outcomes.

21. The gaming terminal of claim 1, wherein said wager-input means includes at least one network-based account.

22. The gaming terminal of claim 1, wherein said buttons are mechanical.

23. The gaming terminal of claim 1, wherein said buttons are proximity sensors.

24. A method of conducting a wagering game on a gaming terminal having a main display, a secondary display, and a button panel with a plurality of mechanical buttons, said secondary display being located between said button panel and said main display, said method comprising:
displaying, at said secondary display, information related to wager inputs received from a player at said gaming terminal;
in response to said wager inputs, conducting a wagering game, said conducting including selecting a randomly selected outcome from a plurality of outcomes; and
displaying, at said main display and said secondary display, game-play information related to said wagering game.

25. The method of claim 24, wherein said secondary display is located directly adjacent to said button panel.

26. The method of claim 24, wherein said secondary display is directly contiguous with said button panel.

27. The method of claim 24, wherein said game-play information related to said wagering game displayed at said secondary display is a pay table.

28. The method of claim 27, further comprising adjusting payout values in the pay table according to at least one of the wagered coins, bonus spins, and bonus pay events.

29. The method of claim 24, wherein said game-play information related to said wagering game is displayed in unison to illustrate continuous movement of images from said main display to said secondary display and from said secondary display to said main display.

30. The method of claim 24, further comprising showing at least a part of said game-play information on a third display.

31. The method of claim 30, further comprising showing a pay table on said third display above said main display.

32. The method of claim 31, further comprising advancing the pays of the pay table according to at least one of the wagered coins, bonus spins, and bonus pay events.

33. The method of claim 30, further comprising showing advertising information on said third display.

34. The method of claim 30, wherein said game-play information is displayed in unison to illustrate continuous movement of images from said third display to at least one of said main display and said secondary display and from said at least one of said main display and said secondary display to said third display.

35. The method of claim 24, further comprising receiving said wager inputs and player-identification inputs at a gaming input region located between said main display and said button panel and to the side of said secondary display.

36. The method of claim 24, wherein said secondary display includes a touch screen for receiving inputs, and said game-play information includes game-play selections to be selected by the player for determining said randomly selected outcome.

37. A gaming terminal for playing a game of chance, comprising:
a housing having a wager-input means;
a main display located within said housing, said main display displaying a randomly selected outcome from a plurality of outcomes of said wagering game in response to receiving a wager from said wager-input means;
a secondary display mounted to said housing below said main display, said secondary display and said main display acting in unison to illustrate continuous movement of images related to said randomly selected outcome from said secondary display to said main display and from said main display to said secondary display;
a touch screen over said secondary display for receiving inputs from the player; and
a button panel mounted below and contiguous with said secondary display, said button panel including a plurality of mechanical buttons for receiving inputs from a player.

38. The gaming terminal of claim 37, wherein said inputs received at said touch screen over said secondary display are game-play inputs.

39. The gaming terminal of claim 37, wherein said inputs received at said touch screen over said secondary display are wagering inputs.

40. The gaming terminal of claim 37, wherein said inputs received at said touch screen over said secondary display are player-identification inputs.

41. A gaming terminal for conducting a wagering game, comprising:
a housing having at least one of a wager-input means and a player-identification device for receiving player-identification information;
a button panel on said housing including a plurality of mechanical buttons for receiving inputs from a player;
a plurality of mechanical reels for displaying a randomly selected outcome from a plurality of outcomes of said wagering game in response to receiving a wager from said wager-input means; and
a secondary display located within said housing between said button panel and said plurality of mechanical reels, said secondary display being contiguous with said button panel, said secondary display displaying information about at least one of said wager inputs and said player-identification information and, during said wagering game, displaying game-play information related to said plurality of outcomes.

42. The gaming terminal of claim 41, wherein said secondary display is adapted to show a pay table indicating the payout amounts for winning outcomes of said plurality of outcomes.

43. A gaming terminal for conducting a wagering game, comprising:
a housing having at least one wager-input means and a player-identification device;
a button panel on said housing including a plurality of mechanical buttons for receiving inputs from a player;
a main display located within said housing, said main display displaying a randomly selected outcome from a plurality of outcomes of said wagering game in response to receiving a wager from said wager-input means;
a secondary display located within said housing between said button panel and said main display, said secondary display displaying information about said wager inputs and said player-identification information; and
a touch screen over said secondary display for receiving inputs from said player.

44. The gaming terminal of claim 43, wherein said secondary display is directly contiguous with said button panel and directly adjacent to said wager-input means and said player-identification device.

45. The gaming terminal of claim 43, wherein said main display and said secondary display act in unison to illustrate continuous movement of images from said main display to said secondary display and from said secondary display to said main display.

46. The gaming terminal of claim 43, wherein said secondary display is adapted to show a pay table indicating the payout amounts for winning outcomes of said plurality of outcomes.

47. The gaming terminal of claim 43, wherein said inputs received at said touch screen over said secondary display are game-play inputs.

48. The gaming terminal of claim 43, wherein said inputs received at said touch screen over said secondary display are wagering inputs.

49. The gaming terminal of claim 43, wherein said inputs received at said touch screen over said secondary display are player-identification inputs.

50. The gaming terminal of claim 43, further comprising a third display, said third display and at least one of said main display and said secondary display acting in unison to illustrate continuous movement of images from said third display to said at least one of said main display and said secondary display and from said at least one of said main display and said secondary display to said third display.

51. The gaming terminal of claim 50, wherein said third display includes a touch screen, said touch screen overlying over at least a portion of said third display.

52. A method of conducting a wagering game on a gaming terminal having a main display, a secondary display, and a button panel with a plurality of mechanical buttons, said secondary display being located between said button panel and said main display and adjacent to said button panel, said method comprising:
displaying, at said secondary display, player-identification information received from a player at said gaming terminal;
conducting a wagering game in response to wager inputs, said conducting including selecting a randomly selected outcome from a plurality of outcomes; and
displaying, at said main display and said secondary display, game-play information related to said wagering game.

53. The method of claim 52, wherein said game-play information related to said wagering game displayed at said secondary display is a pay table.

54. The method of claim 52, wherein said game-play information related to said plurality of outcomes is displayed in unison to illustrate continuous movement of images from said main display to said secondary display and from said secondary display to said main display.

55. The method of claim 52, further comprising showing at least a part of said game-play information related to said plurality of outcomes on a third display above said main display.

56. The method of claim 52, wherein said secondary display includes a touch screen for receiving inputs, and said game-play information includes game-play selections to be selected by the player for determining said randomly selected outcome.

57. The method of claim 56, wherein said game-play selections are selected in a bonus game.

58. A gaming terminal for conducting a wagering game, comprising:
a housing having wager-input means;
a button panel located directly below said wager-input means on said housing and including a plurality of buttons for receiving wager inputs from a player;
a main display located within said housing, said main display for displaying a randomly selected outcome from a plurality of outcomes of said wagering game in response to receiving a wager at said wager-input means;
a secondary display located within said housing between said button panel and said main display, said secondary display being to the side of said wager-input means, said secondary display displaying information about said wager inputs received from said wager-input means and, during said wagering game, displaying game-play information related to said plurality of outcomes; and
a third display for displaying information about a bonus game or a progressive game, said third display being mounted below said main display.

59. The gaming terminal of claim 58, wherein said third display is directly contiguous with said button panel and directly to the side of said secondary display.

60. The gaming terminal of claim 58, wherein at least two of said main display, said secondary display, and said third display act in unison to illustrate continuous movement of images from at least one of said main display, said secondary display, and said third display to at least one of said main display, said secondary display, and said third display.

61. The gaming terminal of claim 58, wherein said third display is adapted to show a pay table indicating the payout amounts for winning outcomes of said plurality of outcomes.

62. The gaming terminal of claim 58, wherein said third display is adapted to show advertising information.

63. The gaming terminal of claim 58, wherein said third display includes a touch screen overlying at least a portion of said third display.

64. The gaming terminal of claim 58, wherein said main display, said secondary display, and said third display are each selected from a group consisting of a cathode ray tube, a high resolution LCD, a plasma display, and a LED.

65. A method of conducting a wagering game on a gaming terminal having a main display, a secondary display, a third display, and a button panel with a plurality of mechanical buttons, said secondary display and said third display being located between said button panel and said main display, said method comprising:
displaying, at one or more of said secondary display and said third display, information related to wager inputs received from a player at said gaming terminal;
in response to said wager inputs, conducting a wagering game, said conducting including selecting a randomly selected outcome from a plurality of outcomes; and
displaying, at said main display, said secondary display, and said third display game-play information related to said wagering game.

66. The method of claim 65, wherein at least one of said secondary display and said third display is located directly adjacent to said button panel.

67. The method of claim 65, wherein at least one of said secondary display and said third display is directly contiguous with said button panel.

68. The method of claim 65, wherein said game-play information related to said wagering game displayed at one or more of said secondary display and said third display is a pay table.

69. The method of claim 65, wherein said game-play information related to said wagering game is displayed in unison to illustrate continuous movement of images from at least one of said main display, said secondary display, and said third display to at least one of said main display, said secondary display, and said third display.

70. The method of claim 65, further comprising showing advertising information on said third display.

71. The method of claim 65, wherein said third display is located adjacent to and to the side of said secondary display.
